(19) United States
(12) Patent Application Publication
(10) Pub. No.: US 2015/0032711 A1
(43) Pub. Date: Jan. 29, 2015

(54) METHODS FOR IDENTIFICATION OF ORGANISMS, ASSIGNING READS TO ORGANISMS, AND IDENTIFICATION OF GENES IN METAGENOMIC SEQUENCES

(71) Applicant: Victor Kunin, San Rafael, CA (US)

(72) Inventor: Victor Kunin, San Rafael, CA (US)

(21) Appl. No.: 14/323,806

(22) Filed: Jul. 3, 2014

Related U.S. Application Data
(60) Provisional application No. 61/843,376, filed on Jul. 6, 2013.

(51) Int. Cl. G06F 19/22; G06F 17/30

(52) U.S. Cl. CPC G06F 19/22; G06F 17/30864; G06F 17/30595
USPC 707/706

(57) ABSTRACT

The present application provides a computational procedure that receives metagenomic or metatranscriptomic sequence reads. Briefly, the computational procedure comprises masking or removal of low-complexity, highly conserved and vector sequences; read mapping using homology searches to a database comprising genomes; post-processing the search results to identify organisms that are present in the data and remove false positives. Functional annotation are propagated from the mapped genomes. The output comprises inferred mapping of input reads to organisms, genes and functions of the reference database.

### CROSS-REFERENCE TO RELATED APPLICATIONS

This application claims the benefit of U.S. Provisional Application 61/843,376, filed Jul. 6, 2013. The disclosure of the referenced application is incorporated by reference herein in its entirety.

### INTRODUCTION

The identification of microorganisms in the environment is a task with ever rising importance. In December 2012, Defense Advanced Research Projects Agency (DARPA) called an Innocentive challenge to identify microorganisms from stream of DNA sequences. The Challenge provided several datasets, which contained output from sequencing machines. The Solvers of the Challenge were required to identify organisms from which the sequences (reads) were derived, assign reads to these organisms, and identify genes present in the reads. The Challenge specified that the sequences were derived from humans and microorganisms, and as the host is known the genes and reads of the host do not need to be reported.

The Invention describes a computational procedure that allows to solve the Challenge. In alternative embodiments the Invention can be practiced to identify organisms, assign reads and identify genes in any metagenomic sample, regardless of origin or type of the source from which the metagenomic sequence was derived. The Invention can also be used to identify organisms, assign reads to organisms and identify genes in simulated datasets. The simulation can include artificial combination of DNA from various sources with subsequent sequencing, or combination of data derived from different sequenced sources.

In alternative embodiments the invention is applicable to metatranscriptomic datasets. In alternative embodiments RNA can be extracted from the sample, reverse-transcribed to DNA and sequenced. The RNA can be the entire RNA from the sample, or optionally enriched for mRNA with rRNA and optionally tRNA molecules removed prior to sequencing. The procedure described below can be applied to RNA sequences as well as DNA sequences. For RNA sequences an additional step of counting gene abundance is optionally required.

### PROCEDURE

### Reference Database

The Challenge specified that the organisms in the samples are expected to be human-associated pathogens. This information greatly restricts the number of possible organisms that can possibly be identified in the sample. This restriction is important. Microbial diversity is immense, and only a small fraction has been covered by genome projects. However, medically-relevant, human-associated pathogens were specifically targeted for genome sequencing, generating a plausible assumption that most human-associated pathogens have been already sequenced. This assumption allows usage of complete genome sequences as reference.

Usage of complete genomes has the advantage of a dataset which has a considerable amount of human curation. Partial genome sequences, or genomic fragments often do not have receive the level of scrutiny of complete genome sequences, and contain artifacts, sometimes derived from vectors or contamination. Usage of the complete genome sequences allows to avoid those artifacts. However, in alternative embodiments incomplete (draft) genomes can be used, and this includes sequences submitted to public databases in which the organism of origin is identifiable. In addition, as more genomes are continuously sequenced, the Invention will be applicable to other type of datasets, and not only for human-associated microorganisms.

Genomes can be downloaded from several locations. For example, RefSeq or NCBI genomes websites provide an opportunity to download each genome separately or groups of genomes in bulk. The status of each genome (complete vs draft) is publicly available, as well as predictions of location and function of each gene and taxonomic information for each genome. In alternative embodiments, private data banks can be used, adding more genomes to the collection.

The availability of taxonomic information allows to avoid downloading ‘unwanted’ genomes or remove them after downloading. A genome is ‘unwanted’ if it's clear from the sample description that it is either not in the data or alternatively is present but information is not sought. For example, in the case of the above-mentioned DARPA challenge it's expected that human genome will be in the data, however the information is not sought, therefore this genome can be excluded from the dataset. Moreover, the description of the challenge implied that only microorganisms should be reported. This definition excludes most animals and plants, and those can be removed from the database. However, this removal is optional, as ‘masking’ procedure described below are designed to reduce the ability of the ‘unwanted’ genomes to generate false positives.

The set of genomes or organisms may include Bacteria, Archaea, Viruses, Eukaryotes, Plasmids, Vectors, Synthetic or artificial sequences and any subset of those. For the sake of the DARPA challenge, plants and animals may be excluded.

### Masking

Procedures described in the Masking section must be performed either on the Reference Database or on reads, or on both.

### Low-Complexity Regions

Sequence similarity comparison is only meaningful when it can find common origin. However, significant scores can be obtained for sequences when there is no common origin. So-called low-complexity sequences contain biased nucleotide or amino acid compositions and their similarities are not indicative of common origin. There are many algorithms and programs to remove or ‘mask’ low-complexity regions (e.g. DUST). Usually these programs substitute bases in the relevant sequence with a neutral character, such as N in nucleotide sequence. The sequence similarity search program then ignores all neutral characters (bases). The masking can be performed either on the database or the reads, or both.

### Human DNA

Human DNA can be identified in the reads using sequence search, and the reads with significant hits removed. However, this is an optional procedure. With proper masking of conserved and low-complexity regions no hits beteween human DNA and microbial DNA are expected. The exclusion of human DNA can be done using nucleotide homology search and removing (or marking for removal) reads that generate significant hits.

### Conserved Regions

The speed of evolution differs across the genome. Some parts of the genome perform very important functions and therefore are conserved across vast taxonomic distances. When these regions are relatively long, they have the potential of causing ‘false positives’, as the conserved region on the read is matched with a conserved region in the database, but in another species. Therefore the highly conserved regions must be identified before a search is performed.

The most conserved genes are ribosomal RNA (rRNA), both the small subunit (16S/18S) and large subunit (23S/28S). Since those genes are sufficiently similar in all organisms, they must be marked as regions not containing sufficient phylogenetic signal.

There is a variety of ways to remove conserved regions, some examples detailed below.

For example, the regions annotated as rRNA can be marked as ‘irrelevant’ for organism identification. This could be done by collecting the information from the annotated genomes, and compiling a table of organisms, chromosomes, and chromosomal positions containing rRNA (herein Exclusion Table). However, this method relies on the annotation of rRNA being correct in all genomes, which does not always hold.

Another method of identifying rRNA regions is by direct search of rRNA in the Reference Database (or collection of reads) vs known rRNA sequences using homology programs. Those programs include megablast, blast, bowtie, bwa, hummer and others, and they have different parameters and thresholds. However, they all take known rRNA as reference(s) and find homologous regions in the query (reads or Reference Database). The result can be post-processed to add entries to the Exclusion Table, which can optionally be combined with a data generated in the procedure described in the previous paragraph.

The conserved regions, whether rRNA or not, can be identified directly by nucleotide searches. For example, the DARPA challenge contained human sequences but the main interest was in microorganisms. Any microbial sequence with similarities to human sequences can therefore interfere in the search and produce false positives. These microbial sequences can be found by comparing reference database against human genome using nucleotide sequence comparison, and recorded in the Exclusion Table.

The removal of conserved regions is needed to reduce the number of hits between a read and reference database to a manageable level. At present the reference database of genomes is rather small, however the number of genomes is expected to raise exponentially with time. With more genomes available, more regions would be generating unmanageable number of hits. Those regions should be identified too, and removed by searching Reference Database against itself and identifying regions that produce a number of hits that approaches or exceeds the number of hits that sequence similarity program or post-processing programs can handle. These entries can also be added to the Exclusion Table.

### Masking of Vector Sequences

Vectors are sequences that allow cloning and multiplication of a sequence of interest. Depending on the sequencing technology, the sequencing procedure may involve cloning the sequence into a cloning vector, and sequencing the insert. Sometimes the vector sequences are erroneously not trimmed and submitted to the database. These vector sequences are sometimes erroneously annotated as the sequence of interest. For example, a microbial pathogen can be sequenced after being cloned into a vector, and the sequences of both the vector and pathogen deposited to a database under the name of the pathogen. The vector may be present in the reads, and a hit may be generated between the vector in the reads and an erroneously annotated sequence in the database. It is therefore important to identify the presence of vectors in the database and/or on the reads. This identification can be done by nucleotide comparison of known vectors to the database of interest (reads or Reference Database) and marking or removal of the sequence regions that have significant similarities to a vector (see below for discussion of significance). Optionally, these regions can be added to the Exclusion Table.

### Homology Searches

### Read Masking

Low-complexity regions in the reads can be optionally masked before performing the search. This masking must be performed on either reads or Reference Database or on both Reads and Reference database. Vector and conserved sequences can be removed from the reads, or marked for removal in the Exclusion Table.

### Search Engines

There is a verity of tools that allow nucleotide searches. Those include blastn, megablast, bowtie, bwa and usearch among others. Any of those tools can be used for performing the search. The result of the nucleotide search engine is an alignment between a query and a database hit. In many cases the sequence search programs calculate significance of the alignment, which includes e-value, length of the overlap, percent identity, etc. When the alignment is available but the signficance estimates are not, those can be calculated from the alignment using established statistics methods (for example, using Karlin-Altschul statistics).

### Shredding of the Reads

While some search engines are relatively tolerant to the length of the read, all have some form of the longest query allowed. For some other methods, such as bowtie, reads of several kilobases (Kb) long can not be aligned. The query must not exceed the maximum query length that is allowed by the search engine, otherwise the search engine would not be able to produce accurate results. For example, bowtie can not use align whole 5 kb-long read that is an output of a PacBio sequencer. Those long reads can be shred into ‘shredded reads’. For example, if bowtie is used, all reads longer than 1,000 bp can be shred into simulated reads of 1,000 bp or shorter, and edges of the reads can overlap for 100 bp. The exact numbers for those 3 length thresholds can be calibrated for each nucleotide search engine.

### Performing the Searches

Homology searched is performed with a search engine using reads (masked and/or shredded or otherwise) as queries and Reference Database (masked or otherwise) as database. The query and the hit may be optionally reversed, yet the embodiment in which reads are used as a query is preferred. The output of the search is a computer data structure in which regions in reads are aligned with regions in the genomes from the Reference Database.

### Post-Processing the Searches

### Gaps

The DARPA challenge contained reads obtained with at least 4 different sequencing technologies. Those included Roche 454, Illumina, Life Sciences Ion Torrent and PacBio. Each of those have its own error rates and biases. However the majority of errors in all but PacBio sequencers can be attributed to erroneous estimation of a homopolimer length. On PacBio sequencer the errors appear as random insertions, and sometimes deletions of several nucleotides. All those errors appear as gaps on an alignment to a template. Therefore to correct for those mistakes, for the sake of calculation of thresholds, gaps of the alignments in the output of a Search Engine can be ignored and not penalized as habitual for sequence alignment and algorithms calculating significance parameters.

### Estimation of Hit Significance

The significance of each potential alignment (or hit) reported by the Search Engine must be assessed, and only significant alignments retained. This evaluation of the significance may be performed by the search engine, when possible, or/and by post-processing the Search Engine output. Gaps may be excluded from the calculation of the significance parameters. Significance parameters include e-value, coverage of the read, and percent identity. E-value can be calculated for example, using Karlin-Altschul statistics, with possible correction for not penalizing gaps. Thresholds for considering an alignment significant must be set. Those may include 90% identity or higher and alignment covering 30% of the read or higher and e-value of 0.00001 or lower. Alignments output by the Search Engine that do not pass the significance thresholds are discarded.

### Mapping Reads to Organisms

The output of the homology searches is a list of alignments or hits. All hits to the regions listed in the Conserved Regions data structure are excluded from the procedure that identifies organisms in the sample.

Some reads may have hits in a single genome in the database. Those reads are very informative, and they suggest that the organism from the genome was derived (or a close relative) was present in the sample from which reads were derived. This organism may be added to the list of Candidate Organisms.

Other reads may have hits in several different genomes. Those genomes can be added to the list of Candidate Organisms.

While a single read can have hits in several organisms, unless the read is chimeric, it was derived from a single organism that was present in the sample. While all potentially present organisms can be reported, this list would contain false positives. Therefore the list of Candidate Organisms must be assessed to identify organisms that explain the presence of most of the reads, while making the Organisms List shortest possible. This procedure is therefore seeks a Most Parsimonious solution of the list of organisms, that is, identification of the minimal number of organisms that can explain all reads in the sample.

### Finding the Most Parsimonious List of Organisms

The identification of the most parsimonious List of Organisms can be done by various methods. This step is designed to remove false positives from the Candidate List of Organisms.

Given that low-complexity regions were masked and conserved areas are excluded, and proper thresholds are put in place to remove spurious hits, the fact that a read hits several genomes points out to the fact that this region is conserved between genomes in question. Typically, those genomes would be somewhat related. For example, the genomes that a read hits may be derived from strains of the same species, or species of the same genus. For example, several species of Brucella are more than 95% identical across most of their genomes, and reads derived from a single strain would potentially hit all or most genomes derived from the genus Brucella. Another example is the vast similarity between the genomes of Escherichia coli and Shigella sp., probably caused by erroneous classification of the two into different genera.

An example of a procedure that would identify false positives in Candidate Organisms List can be as following. For each organism in Candidate Organisms List, find the number of reads that hit this organism. Find the organism A with the largest number of reads hitting it. Record organism A in the list of Organisms List and assign all the reads that hit organism A to Organism A; remove reads that map to this organism from the pool of reads. Repeat the procedure with the new pool of reads until no reads left.

Optionally, even reads that do not not hit organism A can be derived from Organism A. This may be because a read covers an area that is deleted in the reference genome. The reads that cover this region will not have a hit in the reference genome of organism A, however they will have the same % identity to other genomes as other reads that are assigned to organism A, and therefore assigned to Organism A. This rule can be used for identification of areas that are deleted in the reference genomes.

Another procedure for identifying the most parsimonious list of organisms is identification of the common ancestor of the reads, and assigning reads to the taxonomic node representing the common ancestor. For example, a read that has hits to several genomes in the Brucella genus can be assigned to the genus Brucella. This procedure can be done on any level of taxonomic hierarchy. This procedure can be used alone or in combination with procedure described above to identify the List of Organisms and assignment of reads.

The result of the procedure described in this section is the most parsimonious List of Organisms and a list of assignments of reads to organisms.

### Identification of Genes

Once the List of Organisms is identified, and reads are assigned to organisms, genes present in the sample can be identified. The simplest procedure involves simple look up of coordinates of the alignment of the reference sequence and identification of genes present in this sequence from genome annotation. Alternatively, all reads assigned to each genome can be collected to create a map of the covered area in a genome, and all genes present in the area reported as present.

### Mapping Identifiers

Identifiers for genes differ across databases. However, mapping files (and methods for mapping databases) exist, and are publicly available. For example MagicMatch can be used to identify identical sequences across databases. The identifiers in the report may be substituted for identifiers in the preferred database.

Alternatively, genome annotation is not required, and genes can be predicted de novo by using homology-based functional prediction methods. A large collection of such methods is available and those are well-known in the art.

### Compiling a Report

The List of Organisms, read assignments to organisms, and genes need to be stored in a computer-readable format. For the case of the DARPA challenge, these would be compiled into an XML-formatted file. However, for other purposes other forms of data storage and presentation can be used, such as files, databases, lists or any representation in a computer memory or on a drive.

### DRAWINGS

FIG. 1. An variant of an embodiment of the Database Preparation step of the algorithm.

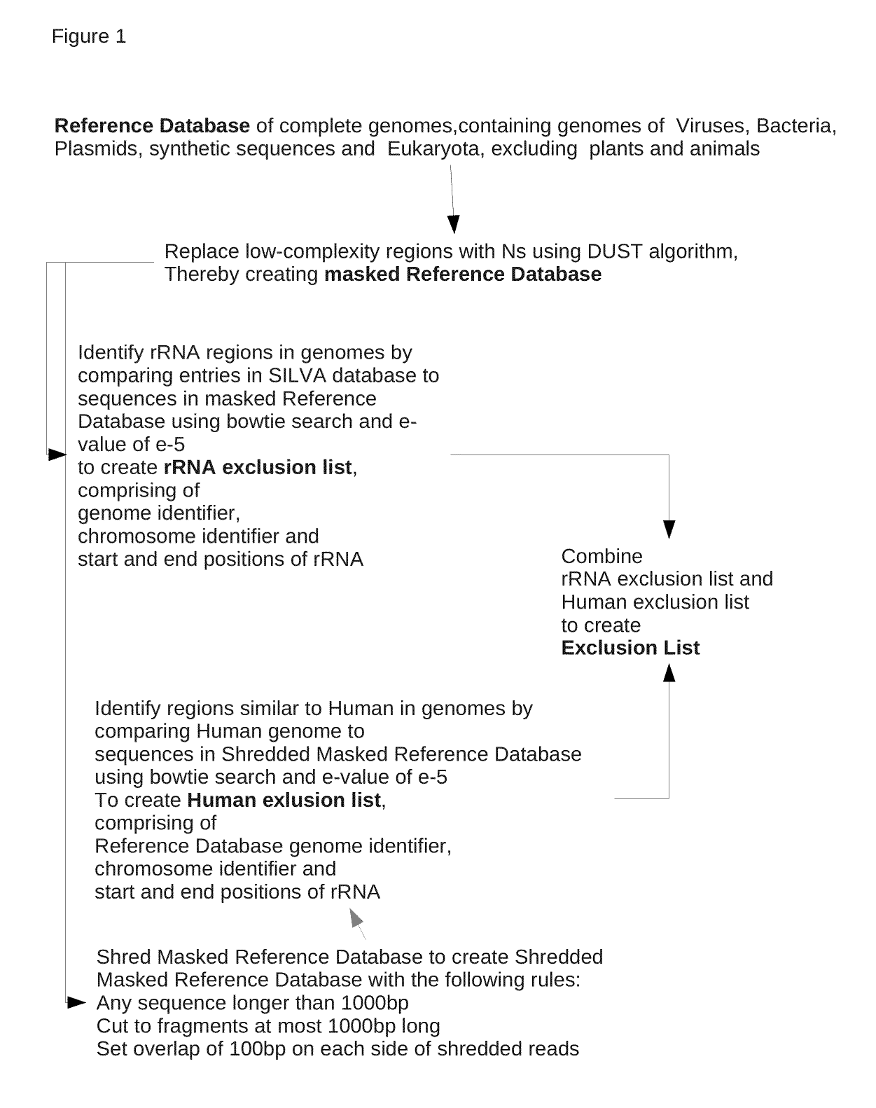

FIG. 2. A variant of an embodiment of the claim 1, that follows the Database Preparation step shown in FIG. 1.

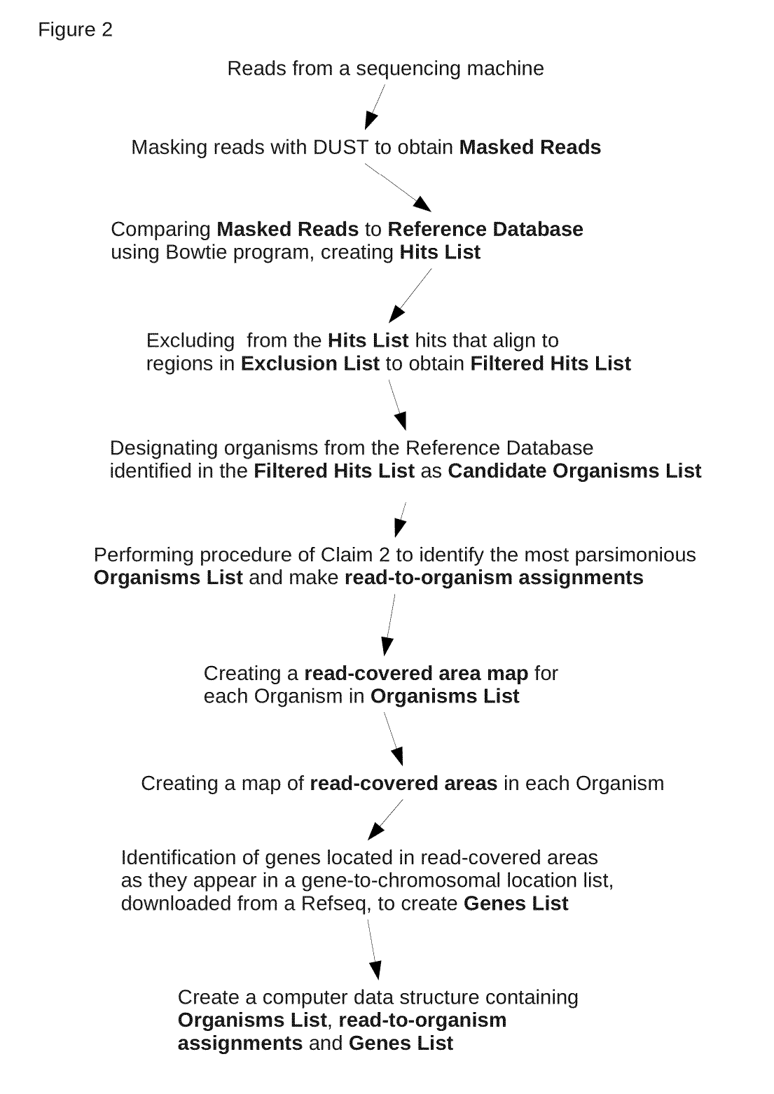

FIG. 3. An illustration of read shredding.

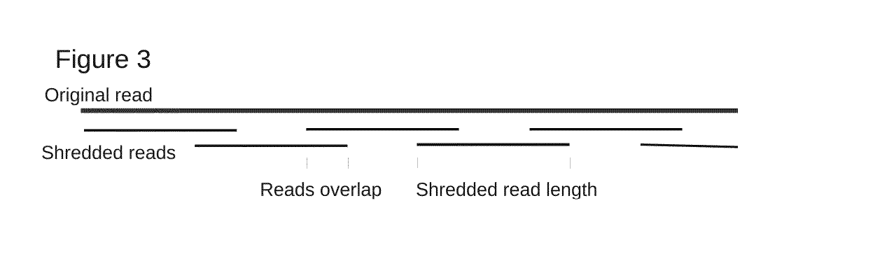

1.
1) Given a collection of sequences, or ‘reads’, optionally derived from a sequencing instrument or a public database;
2) Use, or compile a collection of genomes as a Reference Database
a) wherein genomes are optionally complete genomes or draft genomes, or sequences for which source organism is identified
b) wherein genomes are optionally microbial genomes
c) wherein ‘complete genome’ or ‘draft genome’ is defined by the sequencing center or the database from which the genomes are obtained;
d) wherein ‘microbial’ comprises of all genomes, or any selection of genomes comprising Bacteria, viruses, Archaea, unicellular eukaryotes, fungi, plasmids, vectors and artificial sequences;
e) wherein genomes comprises of nucleotide sequence of chromosomes and plasmids of the organism;
f) wherein the collection can be obtained or compiled from public or private database, which is optionally Refseq or GenBank or NCBI Genomes database;
3) Perform masking of low-complexity sequences and create an Exclusion Table of conserved sequences and optionally vector sequences
a) wherein ‘conserved sequences’ optionally include rRNA and sequences with similarities to human DNA
b) wherein ‘sequences with similarities to human DNA’ comprise sequences in the Reference Database that have similarities to human genome, as defined by procedure in steps 4 and 5 in which ‘reads’ are substituted with genomes from the Reference Database,
c) wherein rRNA optionally comprises 16S rRNA, 23S rRNA, 45S rRNA, 18S rRNA and 28S rRNA,
d) wherein masking can be performed on the Reference Database, or on the reads, or both,
e) wherein masking comprises of identifying region that needs to be masked AND
i. replacing nucleotides in the masked region with a nucleotide, ignored by the nucleotide search or mapping program in step (5), wherein ignored nucleotide is optionally N AND/OR
ii. creating an Exclusion Table, which is a computer-readable data structure that lists the regions identified in step (3-d-i)
4) Optionally shred reads longer than ‘long read threshold’ into shredded reads equal in size or shorter than ‘longest read threshold’, with overlap between shredded reads on both sides ‘overlap threshold’—long
a) wherein ‘long read threshold’ is equal to or shorter than the longest read Search Engine can use as a query, and is optionally 100 bases or longer but no longer than the longest input read
b) wherein ‘longest read threshold’ is optionally 100 bases or longer, but not longer than the longest read in step 4a,
c) wherein ‘overlap threshold’ is optionally 0 bases or longer, but less than threshold B
d) wherein this step is required (not optional) if the Search Engine of step (5) has a limitation of query sequence length,
5) Perform nucleotide search, or read mapping, using Search Engine, of reads to the Reference Database, thereby identifying reference sequences for each read, jointly named ‘hit list’, wherein the alignment between the read and the reference sequences (or ‘hits’) satisfies all of or any of the following thresholds: read coverage, e-value threshold and identity threshold
a) wherein ‘reads’ comprise shredded reads from step 4 (if step (4) was performed), otherwise reads from step 1; or optionally any combination of reads from step (1) and (4)
b) wherein ‘read coverage threshold’ comprises of the aligned region being at lest X% of the read, wherein X is between 50% to 100%
c) wherein ‘e-value’ is optionally calculated by Karlin-Altschul statistics, and e-value is 0.001 or lower, but preferably lower than 0.0000000001,
d) wherein ‘identity threshold’ is sequence identity value between 80% and 100%,
e) and optionally thresholds in (b), (c) and (d) are calculated without including alignment gaps in the calculation
f) and regions contained in the Exclusion Table are excluded or discarded
6) Identity Organisms List or Candidate Organisms List, and assign reads to organisms by
a) identify organisms from which the hits were derived, to compile Candidate Organisms List
b) select organisms from Candidate Organisms List, thereby creating Organisms List, and assign reads to Organisms by
i. assigning reads that hit one organism to that organism and listing the organism in the Organisms List and
ii. identifying reads that map to more than one organism and selecting a single organism from Candidate Organisms List to assign read,
wherein optionally reads are preferentially assigned to organisms to which more reads are assigned, wherein ‘assigning reads’ comprises of recording that a read is identified to belong to the organism in a computer data structure;
7) Identify genes present in the reads by one of the following methods:
i. use coordinates of the chromosomal regions which hit reads to find gene predictions. wherein gene predictions are optionally derived from publicly available records,
ii. use similarity search to identify genes with highly similar sequences (at least 20% identity, but preferably more than 90% identity) in public or private databases containing genes or proteins and transfer annotation from the most similar gene;
iii. use one of the wide variety of available tools for gene functional prediction based on sequence similarity as a method for identification of function.
8) Combine the output of steps 6 and 7 into a machine- or human-readable format.

2. A method in claim 1, in which reads are assigned to organisms using the following procedure:
1) For a collection of reads
a) Find the List of Candidate Organisms that have hits to the Collection of Reads
b) Find the Candidate Organism to which the largest number of reads have hits and designate this organism as Organism A
c) Add Organism A to Organisms List
d) Designate reads that hit Organism A as assigned to organism A
e) Remove reads that hit Organism A from the collection of reads
f) Repeat steps 1 to d as long as collection of reads is non-empty and step (c) contained more than 0 reads.
2) From the Organisms List remove organisms to which no reads are assigned or a number of assigned reads no greater than X
wherein X is any number below 100 but greater than 0;
3) Record Organisms List and all assignments of reads to organisms in a computer data structure.
